(19) United States
(12) Patent Application Publication
(10) Pub. No.: US 2019/0012683 A1
(43) Pub. Date: Jan. 10, 2019

(54) METHOD FOR PREDICTING PURCHASE PROBABILITY BASED ON BEHAVIOR SEQUENCE OF USER AND APPARATUS FOR THE SAME

(71) Applicant: SK PLANET CO., LTD., Seongnam-si (KR)

(72) Inventors: Woo-Hyuk JANG, Hwaseong-si (KR); Yun-Seok JANG, Seoul (KR); Choon-Oh LEE, Suwon-si (KR); Young-Sook Hwang, Seongnam-si (KR)

(73) Assignee: SK PLANET CO., LTD.

(21) Appl. No.: 16/030,054

(22) Filed: Jul. 9, 2018

(30) Foreign Application Priority Data
Jul. 10, 2017 (KR) 10-2017-0087311

(51) Int. Cl. G06Q 30/02; G06F 17/30

(52) U.S. Cl. CPC G06Q 30/0202; G06F 17/30887

(57) ABSTRACT

Disclosed herein are a method for predicting a purchase probability based on a behavior sequence of a user and an apparatus for the same. The method and apparatus collect, in real time, logs for a user who accesses a shopping site, generate a Uniform Resource Identifier (URI) sequence corresponding to the online behavior of the user by arranging the logs in temporal sequence, and calculate a product purchase probability of the user by comparing the URI sequence with a purchase probability model corresponding to the shopping site. Further, the current purchase intention of a customer may be more accurately detected, and thus information about a product currently of interest to the customer may be provided.

### CROSS REFERENCE TO RELATED APPLICATION

This application claims the benefit of Korean Patent Application No. 10-2017-0087311, filed Jul. 10, 2017, which is hereby incorporated by reference in its entirety into this application.

### BACKGROUND OF THE INVENTION

### 1. Technical Field

The present invention relates generally to technology for predicting a purchase probability for a product of interest to a customer in an online shopping (e-commerce) site, and more particularly, to a method for predicting a purchase probability based on the behavior sequence of a user and an apparatus for the method, which can quantify and predict a purchase probability for a specific category or for a product present in the specific category, based on the sequence of pages visited by the user within a certain site.

### 2. Description of the Related Art

As competition for online shopping (e-commerce) has deepened at home and abroad, the concept of a “right moment” for identifying and responding to each customer's interest in a specific product or a specific category at an appropriate time has been propagated. A customer shows various types of purchase-related behavior to a seller before actually purchasing a product online (i.e. conversion), and such behavior has characteristics of being more clearly distinguished from those of behavior of a non-purchaser as the customer comes closer to deciding to make a purchase. For example, various actions, such as the action of continuously viewing details of products in the same category, entering a related keyword, or reading reviews on a specific product, the social activity of clicking the “like” button or sharing a specific page, or the action of visiting various URI pages such as adding to a shopping cart or attempting to make a payment, may be considered to be behavior matching those characteristics.

Most purchasing customers have consequently resulted in a purchase while exhibiting those actions more frequently per unit time as they come closer to deciding to make a purchase. In contrast, non-purchasing customers, who are far more numerous than purchasing customers, initially exhibit behavior similar to that of the purchasing customers, but leave the corresponding site without purchasing products. It can be considered that such non-purchasing customers are distracted from the corresponding products, are not satisfied with the prices of the products, or give up purchasing the products from the corresponding site for some other reason. In this way, when it is possible to identify potential customers having a pattern similar to that of purchasing customers, to grasp products of interest to the potential customers, and to respond to the intentions thereof at a suitable time, the so-called conversion rate may be improved.

In relation to this, conventional product recommendation technology has utilized personal information, purchase history, etc. of each customer, etc., but this information is not changed depending on the customer's current interest, and thus there is a limitation in detecting the current intention of the customer. For example, the case where a certain customer browses products that are to be given as gifts and thus are not closely related to the personal member information of the customer or where the customer suddenly starts to search for a product introduced on a TV program may be a situation in which the current interest of the customer is considered to be more important. However, conventional methods are not suitable for responding to such a situation. Actually, in order to detect a product currently of interest to a customer, it may be more accurate to determine actions successively taken in the corresponding shopping site by the customer who visits the shopping site than to utilize the past purchase history or profile information of the customer.

### PRIOR ART DOCUMENTS

### Patent Documents

(Patent Document 1) Korean Patent Application Publication No. 10-2002-0025341, Date of publication: Apr. 4, 2002 (entitled “The personalized agent engine development apparatus for establishing the internet shopping-mall and service method thereof”)

### SUMMARY OF THE INVENTION

Accordingly, the present invention has been made keeping in mind the above problems occurring in the prior art, and an object of the present invention is to provide information about a product currently of interest to a customer by more accurately detecting the customer's current purchase intention.

Another object of the present invention is to improve the timeliness and accuracy of a product to be provided as marketing information to customers by calculating, in real time, the probability of interest of each customer in a specific product or a specific category.

A further object of the present invention is to provide industrially useful information by quantitatively indicating the probability that a user who visits an online shopping site will purchase a product and information about each user who takes interest in the corresponding product or category in the shopping site.

Yet another object of the present invention is to solve a conventional “cold start” problem in which it has been impossible to perform prediction for a new user due to the absence of base data.

In accordance with an aspect of the present invention to accomplish the above objects, there is provided a method for predicting a purchase probability, including collecting, in real time, logs for a user who accesses a shopping site; generating a Uniform Resource Identifier (URI) sequence corresponding to an online behavior of the user by arranging the logs in temporal sequence; and calculating a product purchase probability of the user by comparing the URI sequence with a purchase probability model corresponding to the shopping site.

Calculating the product purchase probability may include generating multiple subsequences, each having a length of at least 1, by extracting multiple URIs constituting the URI sequence such that the URIs are temporally adjacent to each other; and calculating purchase probabilities respectively corresponding to the multiple subsequences based on the purchase probability model and deciding on the product purchase probability based on the purchase probabilities respectively corresponding to the multiple subsequences.

The product purchase probability may be any one of a highest purchase probability, among the multiple purchase probabilities respectively corresponding to the multiple subsequences, an average value of the multiple purchase probabilities, and a median value of the multiple purchase probabilities.

Calculating the product purchase probability may further include extracting a first number of detections that indicates a number of times that each of the multiple subsequences is detected from a purchase pattern corresponding to the purchase probability model, and a second number of detections that indicates a number of times that each of the multiple subsequences is detected from a non-purchase pattern corresponding to the purchase probability model; and calculating the purchase probabilities respectively corresponding to the multiple subsequences by dividing the first number of detections by a sum of the first number of detections and the second number of detections.

Generating the multiple subsequences may be configured to divide the URI sequence into multiple division sequences based on any one of a preset reference length and a preset reference time and to derive the multiple subsequences from each of the multiple division sequences.

Generating the multiple subsequences may be configured to extract at least one URI corresponding to any one of a preset maximum length and a preset maximum time from multiple URIs such that a most recent URI is extracted first in consideration of temporal sequence, and to derive the multiple subsequences from a sequence corresponding to the at least one URI.

Calculating the product purchase probability may be configured to, when time elapses in a state in which additional online behavior does not occur, decrease the product purchase probability as the elapsed time increases.

The method may further include updating the purchase probability model using the URI sequence and purchase results of the user when a behavior cycle of the user for the shopping site ends.

Updating the purchase probability model may be configured to determine a time point of an end of the behavior cycle based on any one of a time point at which the user logs out from the shopping site and a time point at which the user leaves the shopping site.

In accordance with another aspect of the present invention to accomplish the above objects, there is provided a server, including memory for storing logs collected in real time for a user who accesses a shopping site; and a processor for generating a Uniform Resource Identifier (URI) sequence corresponding to online behavior of the user by arranging the logs in temporal sequence, and for calculating a product purchase probability of the user by comparing the URI sequence with a purchase probability model corresponding to the shopping site.

The processor may be configured to generate multiple subsequences, each having a length of at least 1, by extracting multiple URIs constituting the URI sequence such that the URIs are temporally adjacent to each other, calculate purchase probabilities respectively corresponding to the multiple subsequences based on the purchase probability model, and decide on the product purchase probability based on the purchase probabilities respectively corresponding to the multiple subsequences.

The product purchase probability may be any one of a highest purchase probability, among the multiple purchase probabilities respectively corresponding to the multiple subsequences, an average value of the multiple purchase probabilities, and a median value of the multiple purchase probabilities.

The processor may be configured to extract a first number of detections that indicates a number of times that each of the multiple subsequences is detected from a purchase pattern corresponding to the purchase probability model, and a second number of detections that indicates a number of times that each of the multiple subsequences is detected from a non-purchase pattern corresponding to the purchase probability model, and to calculate the purchase probabilities respectively corresponding to the multiple subsequences by dividing the first number of detections by a sum of the first number of detections and the second number of detections.

The processor may be configured to divide the URI sequence into multiple division sequences based on any one of a preset reference length and a preset reference time and to derive the multiple subsequences from each of the multiple division sequences.

The processor may be configured to extract at least one URI corresponding to any one of a preset maximum length and a preset maximum time from multiple URIs such that a most recent URI is extracted first in consideration of temporal sequence, and to derive the multiple subsequences from a sequence corresponding to the at least one URI.

The processor may be configured to, when time elapses in a state in which additional online behavior does not occur, decrease the product purchase probability as the elapsed time increases.

The processor may be configured to update the purchase probability model using the URI sequence and purchase results of the user when a behavior cycle of the user for the shopping site ends.

The processor may be configured to determine a time point of an end of the behavior cycle based on any one of a time point at which the user logs out from the shopping site and a time point at which the user leaves the shopping site.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a system for predicting a purchase probability based on the behavior sequence of a user according to an embodiment of the present invention;

FIG. 2 is an operation flowchart illustrating a method for predicting a purchase probability according to an embodiment of the present invention;

FIG. 3 is an operation flowchart illustrating an example of a procedure for deciding on a product purchase probability by deriving subsequences of a URI sequence in the purchase probability prediction method according to the present invention;

FIG. 4 is an operation flowchart illustrating an example of a procedure for decreasing a product purchase probability in consideration of elapsed time depending on online behavior in the purchase probability prediction method according to the present invention;

FIG. 5 is a diagram illustrating an example of log arrangement results according to the present invention;

FIGS. 6 to 9 are diagrams illustrating examples of URI sequences derived from the arrangement results illustrated in FIG. 5;

FIG. 10 is a diagram illustrating examples of purchase results and URI sequences at a time point at which a behavior cycle according to the present invention ends;

FIGS. 11 and 12 are diagrams illustrating examples of a procedure for creating a purchase probability model based on URI sequences; and

FIG. 13 is a block diagram illustrating a server for predicting a purchase probability according to an embodiment of the present invention.

### DESCRIPTION OF THE PREFERRED EMBODIMENTS

Technical terms used in this specification are used only to describe specific embodiments, and it is to be noted that the terms are not intended to limit the present invention. Furthermore, the technical terms used in this specification should be interpreted as having meanings that are commonly understood by a person having ordinary skill in the art to which the present invention pertains, unless specifically defined otherwise in this specification, and should not be interpreted as having excessively comprehensive meanings or excessively narrow meanings. Furthermore, if the technical terms used in this specification are erroneous technical terms that do not precisely represent the spirit of the present invention, they should be replaced with technical terms that may be correctly understood by a person having ordinary skill in the art. Furthermore, common terms used in the present invention should be interpreted in accordance with the definitions of dictionaries or in accordance with the context thereof, and should not be interpreted as having excessively narrow meanings.

Furthermore, an expression of a singular number used in this specification includes an expression of a plural number unless clearly indicated otherwise by the context. In this application, terms, such as “comprise” and “include”, should not be interpreted as essentially including all of several elements or several steps described in the specification, and should be interpreted as not including some of the elements or steps or as including additional elements or steps.

Furthermore, terms including ordinal numbers, such as “first” and “second” used in this specification, may be used to describe a variety of elements, but the elements should not be limited to the terms. The terms are used to only distinguish one element from another element. For example, a first element may be named a second element, and likewise, a second element may be named a first element without departing from the scope of the present invention.

Hereinafter, preferred embodiments in accordance with the present invention are described in detail with reference to the accompanying drawings. The same or similar elements are assigned the same reference numerals irrespective of reference numerals, and a redundant description thereof is omitted.

In the following description of the present invention, detailed descriptions of known functions and configurations which are deemed to obscure the gist of the present invention will be omitted. The accompanying drawings of the present invention aim to facilitate understanding of the present invention and should not be construed as being limited to the accompanying drawings.

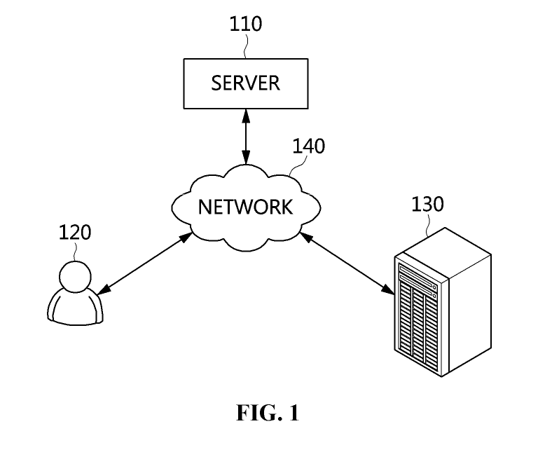

FIG. 1 is a diagram illustrating a system for predicting a purchase probability based on the behavior sequence of a user according to an embodiment of the present invention.

Referring to FIG. 1, the system for predicting a purchase probability based on the behavior sequence of a user according to the embodiment of the present invention includes a server 110, a user 120, an online shopping server 130, and a network 140.

The server 110 according to the embodiment of the present invention may be a device for calculating a product purchase probability using the behavior of the user 120 who conducts online shopping through the online shopping server 130 based on the network 140. That is, the server 110 may acquire information related to online behavior of the user 120 while communicating with the online shopping server 130 over the network 140, and may calculate the product purchase probability of the user 120 by comparing the acquired information with a purchase probability model.

Here, although, in FIG. 1, the server 110 and the online shopping server 130 are separately illustrated, the server 110 and the online shopping server 130 may be the same sever in some cases. That is, the server 110 for calculating the product purchase probability of the user 120 may be included in the online shopping server 130 for providing an online shopping service. In contrast, the online shopping server 130 for providing an online shopping service may be included in the server 110 for calculating the product purchase probability of the user 120.

The server 110 collects, in real time, logs for the user 120 who accesses a shopping site through the online shopping server 130.

The server 110 generates a Uniform Resource Identifier (URI) sequence corresponding to the online behavior of the user 120 by arranging the logs in temporal sequence.

Further, the server 110 calculates the product purchase probability of the user 120 by comparing the URI sequence with a purchase probability model corresponding to the shopping site.

Here, multiple subsequences, each having a length of at least ‘1’, may be generated by extracting multiple URIs constituting the URI sequence so that the multiple URIs are temporally adjacent to each other.

Here, based on any one of a preset reference length and a preset reference time, the URI sequence may be divided into multiple division sequences, and multiple subsequences may be derived from each of the multiple division sequences.

Here, at least one URI corresponding to any one of a preset maximum length and a preset maximum time may be extracted from the multiple URIs so that the most recent URI is extracted first in consideration of temporal sequence, and multiple subsequences may be derived from the sequence corresponding to the at least one URI.

Here, purchase probabilities respectively corresponding to the multiple subsequences may be calculated based on the purchase probability model, and a product purchase probability may be decided on based on the purchase probabilities respectively corresponding to the multiple subsequences.

Here, the product purchase probability may be any one of the highest purchase probability, among multiple purchase probabilities corresponding to the multiple subsequences, the average value of the multiple purchase probabilities, and the median value of the multiple purchase probabilities.

Here, the first number of detections, indicating the number of times that each of the multiple subsequences is detected from a purchase pattern corresponding to the purchase probability model, and the second number of detections, indicating the number of times that each of the multiple subsequences is detected from a non-purchase pattern corresponding to the purchase probability model, may be extracted.

Here, the first number of detections is divided by the sum of the first number of detections and the second number of detections, and thus the purchase probabilities respectively corresponding to the multiple subsequences may be calculated.

Here, when time elapses in the state in which additional online behavior does not occur, the product purchase probability may be decreased as the elapsed time increases.

Further, the server 110 updates the purchase probability model using the URI sequence and the purchase results of the user 120 when the behavior cycle of the user in the corresponding shopping site ends.

The time point of the end of the behavior cycle may be determined based on any one of a time point at which the user 120 logs out from the shopping site and a time point at which the user 120 leaves the shopping site.

The user 120 may be a person who accesses the online shopping server 130 and shows various types of behavior for online shopping. For example, the user 120 may access an online shopping site, and may engage in various types of online behavior, such as searching for products, viewing details of products, adding products to a shopping cart, or attempting to make a payment.

In this case, the user 120 may access the online shopping server 130 using a user terminal, such as a mobile terminal or a computer, and may then conduct online shopping.

For example, a user terminal is a device on which an application according to the present invention may run by being connected with a communication network, and may be any of various types of terminals including all types of information communication devices, multimedia terminals, Internal Protocol (IP) terminals, and the like, without being limited to mobile communication terminals. Also, the user terminal may be a mobile terminal having various mobile communication specifications, such as a mobile phone, a Portable Multimedia Player (PMP), a Mobile Internet Device (MID), a smartphone, a tablet PC, a laptop, a netbook, a Personal Digital Assistant (PDA), an information communication device, and the like.

Further, the user terminal may receive various kinds of information, such as numbers, letters, and the like, and may deliver signals, input for setting various functions and controlling the functions of the user terminal, to the control unit via the input unit. Also, the input unit of the user terminal may be configured so as to include at least one of a keypad and a touch pad, which generate an input signal in response to the touch or manipulation by a user. Here, the input unit of the user terminal and the display unit thereof may form a single touch panel (or a touch screen), thereby performing both an input function and a display function. Also, the input unit of the user terminal may use all types of input means that may be developed in the future as well as currently existing input devices, such as a keyboard, a keypad, a mouse, a joystick, and the like.

The display unit of the user terminal may display information about a series of operation states and operation results generated while the function of the user terminal is being performed. Also, the display unit of the user terminal may display the menu of the user terminal and user data input by a user. Here, the display unit of the user terminal may be configured with a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the user terminal is configured in the form of a touch screen, the display unit of the user terminal may perform some or all of the functions of the input unit of the user terminal. Particularly, the display unit of the user terminal according to the present invention may display an interface provided for the prediction of a purchase probability and information about execution of the application on a screen.

The storage unit of the user terminal may include a main storage device and an auxiliary storage device as devices for storing data, and may store applications that are necessary for the operation of the user terminal. The storage unit of the user terminal may include a program area and a data area. Here, when the user terminal activates each function in response to a request from a user, the user terminal provides the function by running corresponding applications under the control of the control unit. Particularly, the storage unit of the user terminal according to the present invention may store an Operating System (OS) for booting the user terminal, an application for sending and receiving information input for predicting a purchase probability, and the like. Also, the storage unit of the user terminal may store information about the user terminal and a content DB for storing multiple pieces of content. Here, the content DB may include execution data for executing content and attribute information about the content, and may store content usage information in response to the execution of the content. Also, the information about the user terminal may include the specifications of the user terminal.

The communication unit of the user terminal may function to send and receive data to and from the server 110 over the network 140. Here, the communication unit of the user terminal may include an RF transmission medium for up-conversion and amplification of the frequency of a sending signal and an RF reception medium for low-noise amplification of a receiving signal and down-conversion of the frequency thereof. Such a communication unit of the user terminal may include a wireless communication module. Also, the wireless communication module is a component for sending or receiving data based on a wireless communication method, and may send and receive data to and from the server 110 using any one of a wireless network communication module, a wireless LAN communication module, and a wireless PAN communication module when the user terminal uses wireless communication. That is, the user terminal may access the network 140 using a wireless communication module, and may send and receive data to and from the server 110 over the network 140. Particularly, the network 140 according to the present invention may send and receive data that are necessary for the prediction of a purchase probability by communicating with the server 110 or the user terminal.

The control unit of the user terminal may be a processing device for running an Operating System (OS) and respective components. For example, the control unit may control the overall process of accessing the server 110. When access to the server 110 is made through an application, the control unit may control the overall process of running the application in response to the request by a user, and may perform control so as to send a request for using a service to the server 110 simultaneously with execution of the application. Here, the control unit may perform control such that information about the user terminal required for user authentication is sent along with the request.

The online shopping server 130 may be a device for providing an online shopping service to the user 120. That is, the shopping site accessed by the user 120 using his or her user terminal may be operated and managed through the online shopping server 130.

The network 140, which provides a path through which data is transferred between the server 110, the user 120, and the online shopping server 130, may be conceptually understood as including networks that are currently being used and networks that have yet to be developed in the future. For example, the network may be any one of wired and wireless local networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future.

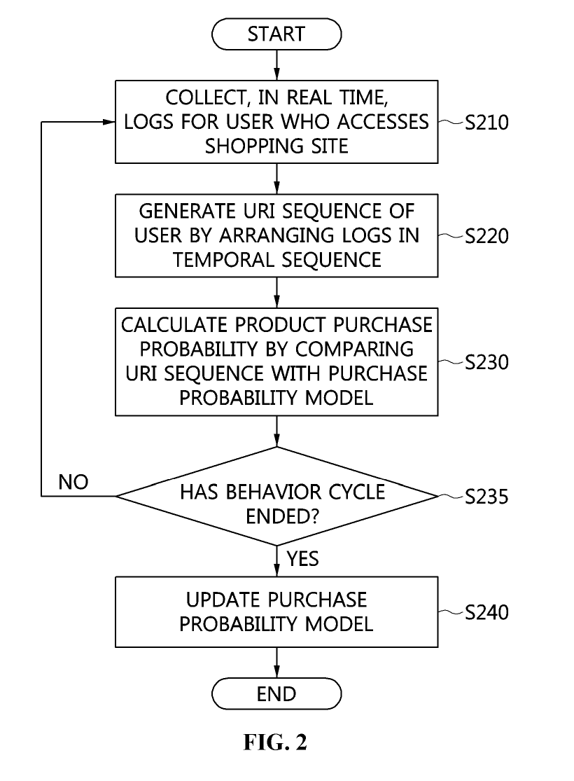

FIG. 2 is an operation flowchart illustrating a method for predicting a purchase probability according to an embodiment of the present invention.

Referring to FIG. 2, the purchase probability prediction method according to the embodiment of the present invention collects, in real time, logs for a user who accesses a shopping site at step S210.

The collected logs may be data about all online behavior of the user when visiting an online shopping site or an e-commerce site and which is related to shopping.

For example, the online behavior may include relatively explicit actions such as the actions of clicking a product, reading product reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring products of interest, such as user experience (UX)-related actions including a mouse wheel control or swipe-out action, or the action of staying on a specific page for a long period of time or revisiting the same product page or a similar category page. However, the online actions are not limited to those examples.

Therefore, all actions taken by the user who accesses the shopping site may be acquired in the form of logs in real time.

Here, the purchase probability prediction method according to the embodiment of the present invention may utilize the above-described real-time online behavior of the user. That is, unlike a conventional scheme, in which a purchase product is recommended or a purchase probability is predicted using the past purchase records or profile information of the user, the present invention may infer a product or category having a strong possibility of being purchased by the user before long, based on a behavior pattern such as which page is currently being visited by the user within the shopping site currently accessed by the user. By means of this scheme, it is possible to more accurately detect the user's current purchase intention.

Here, the logs collected in real time may include the time at which each online action occurs, an ID for identifying the user or the user terminal, an accessed URI, product-related information, etc. In this case, the product-related information included in the logs may include only a product number enabling the type of product to be identified, but category information mapped to a product corresponding to the product number may be acquired based on additional memory or an additional database (DB). Further, the product-related information may also include product-related meta-information, such as a product price or option, by which the degree of importance of online behavior can be determined.

The number of paths through which logs are collected in real time may not be limited to one. For example, logs related to the online behavior of the user may be collected in real time through any of various paths, such as a mobile website, a mobile application, and a PC website.

In addition, the logs may be received in such a way that the server according to the embodiment of the present invention unifies and receives all logs, or in such a way that the server receives a simplified form of logs aggregated by some terminals. Here, the method for receiving logs is not particularly limited to a specific method.

Next, the purchase probability prediction method according to the embodiment of the present invention may generate a Uniform Resource Identifier (URI) sequence corresponding to the online behavior of the user by arranging the logs in temporal sequence at step S220.

When logs for various online actions are collected without identifying users in a specific shopping site, the logs may be classified for respective users, after which the logs may be arranged in temporal sequence.

In this case, the purchase probability prediction method according to the present invention may arrange the logs by adjusting the URI sequence to various levels depending on the product purchase probability of the user, that is, the purpose for using interest information related to a purchase.

In an example, in order to utilize purchase-interest information for each product, the collected logs may be arranged to be aggregated together for respective products.

In another example, in order to utilize purchase-interest information for each product category, the collected logs may be arranged to be aggregated together for respective categories.

Here, respective URIs constituting the URI sequence may be converted into and represented by separate IDs to simplify processing.

For example, in the URI sequence in which URIs are arranged for respective products, a URI corresponding to a product detail page, that is, ‘/Product/Detail’, may be represented by No. 1, a URI corresponding to a shopping cart page, that is, ‘Basket’, may be represented by No. 2, and a URI corresponding to a product payment page, that is, ‘/Pay’, may be represented by No. 3. That is, assuming that the user adds a product to the shopping cart in the product detail page, and thereafter goes to a payment page through the shopping cart page, the URI sequence may be represented by (1, 2, 3).

Here, when a new URI is added to the shopping site due to an external factor, such as the update or renewal of the shopping site, an ID may also be assigned to and used in the added URI.

Each URI may be converted into a short character string using a hashing technique, and the converted character string may also be used as an ID corresponding to the URI.

Here, the URI sequence may be maintained and may then be deleted based on a session, a logout time point, a purchase time point, a time limitation, or the like, according to the service policy that utilizes a product purchase probability. That is, the purchase probability prediction method according to the embodiment of the present invention is intended to detect a product currently of interest to the user who accesses the shopping site and use the product currently of interest for a marketing service, such as the recommendation of a product or the provision of a coupon, and thus there is no need to maintain the generated URI sequence after the user has terminated online behavior in the shopping site. Therefore, to manage at least the memory storage capacity of the server, the URI sequence, the use of which has been completed, may be deleted.

Further, the purchase probability prediction method according to the embodiment of the present invention calculates the product purchase probability of the user by comparing the URI sequence with a purchase probability model corresponding to the shopping site at step S230.

Here, the purchase probability model may be a purchase probability model for the corresponding shopping site. That is, the purchase probability model may be created as a result of deriving all subsequences, that is, all patterns, from each URI sequence collected from the corresponding shopping site, and of applying an association rule to the subsequences using the frequency at which each subsequence appears in a purchase pattern or a non-purchase pattern.

For example, a purchase pattern or a non-purchase pattern may be extracted and included in the purchase probability model, based on a URI sequence which frequently appears when a purchase is made by multiple users who use the corresponding shopping site, or a URI sequence which frequently appears when a purchase is not made by users. Here, a URI sequence, for which the total number of appearances (hereinafter also referred to as “total appearance frequency”) in each pattern does not reach a predetermined number, may be excluded, and thus computing speed at which the purchase probability model is created may be improved.

Therefore, the URI sequence corresponding to the user is compared with the purchase pattern or the non-purchase pattern included in the purchase probability model, and thus whether the user will purchase a product may be calculated in the form of a probability.

At this time, multiple subsequences, each having a length of at least 1, may be generated by extracting multiple URIs constituting the URI sequence so that the multiple URIs are temporally adjacent to each other.

For example, when a URI sequence corresponding to the user is generated to correspond to 1, 2, and 3, six subsequences corresponding to (1), (1, 2), (1, 2, 3), (2), (2, 3), and (3) may be generated. That is, the case of (1, 3), in which URIs are not adjacent to each other, is not derived as a subsequence.

In another example, when a URI sequence corresponding to the user is generated to correspond to 2, 3, 5, and 8, ten subsequences, corresponding to (2), (2, 3), (2, 3, 5), (2, 3, 5, 8), (3), (3, 5), (3, 5, 8), (5), (5, 8), and (8), may be generated. Similarly, the cases of (2, 5), (2, 8), (3, 8), (2, 3, 8), and (2, 5, 8), in which URIs are not adjacent to each other, are not derived as subsequences.

Here, based on any one of a preset reference length and a preset reference time, the URI sequence may be divided into multiple division sequences, and multiple subsequences may be derived from each of the multiple division sequences.

The preset reference length may be the number of URIs.

For example, when the preset reference length is 3 and the URI sequence corresponds to 1, 2, 3, 4, 5, and 6, the URI sequence may be divided into multiple division sequences respectively corresponding to (1, 2, 3), (2, 3, 4), (3, 4, 5), and (4, 5, 6), and subsequences may be derived from each of the division sequences. That is, in the same way as the method for deriving subsequences (1), (1, 2), (1, 2, 3), (2), (2, 3), and (3) from the division sequence (1, 2, 3), subsequences may be derived from the remaining division sequences (2, 3, 4), (3, 4, 5), and (4, 5, 6).

Here, the preset reference time may be a predetermined time unit.

For example, assuming that the preset reference time is 1 minute and that the URI sequence corresponds to 1, 2, 3, 4, 5, and 6, URIs which are collected during a period of one minute from the time at which a first URI corresponding to the URI sequence, that is, a URI No. 1, appears may be aggregated together to generate a single division sequence. That is, assuming that the time at which the URI No. 1 appears is n, URIs appearing during a period from minute n to minute n+1 may be aggregated together to generate a single division sequence, and then subsequences may be derived from the division sequence. Further, URIs appearing during a period from minute n+1 to minute n+2 may be aggregated together to generate an additional division sequence, and then subsequences may be derived from the division sequence. In this way, the above procedure may be repeated to perform division until all URIs included in the URI sequence are included in division sequences.

Here, at least one URI corresponding to any one of a preset maximum length and a preset maximum time may be extracted from the multiple URIs so that the most recent URI is extracted first in consideration of temporal sequence, and multiple subsequences may be derived from the sequence corresponding to the at least one URI.

Here, the most recent URI, among the multiple URIs included in the URI sequence, may be a URI included in the last sequential position in the order of arrangement. Therefore, a number of URIs, corresponding to the preset maximum length or to the preset maximum time and arranged successively from the last URI included in the URI sequence, may be extracted, and then subsequences for the URIs may be derived.

For example, assuming that the URI sequence corresponds to 1, 2, 3, 4, 5, 6, 7, and 8, and that the present maximum length is 4, a sequence is derived to correspond to (5, 6, 7, 8), indicating four URIs from 8, which is the last URI of the URI sequence. Also, (5), (5, 6), (5, 6, 7), (5, 6, 7, 8), (6), (6, 7), (6, 7, 8), (7), (7, 8), and (8) may be derived as subsequences from (5, 6, 7, 8).

In another example, assuming that the URI sequence corresponds to 1, 2, 3, 4, 5, 6, 7, and 8 and that the preset maximum time is 1 minute, URIs appearing during a period from time n at which an URI No. 8, the last URI in the URI sequence, appears to time n−1 may be extracted, and subsequences may be derived from a sequence composed of the extracted URIs.

Here, purchase probabilities respectively corresponding to multiple subsequences may be calculated based on the purchase probability model, and a product purchase probability may be decided on based on the purchase probabilities respectively corresponding to the multiple subsequences.

Here, the purchase probabilities respectively corresponding to the multiple subsequences may be probabilities that the user will purchase a product when acting depending on patterns corresponding to respective subsequences. That is, when the URI sequence corresponds to 1, 2, and 3, purchase probabilities may be calculated for respective subsequences corresponding to (1), (1, 2), (1, 2, 3), (2), (2, 3), and (3), and the product purchase probability may be finally decided on using the calculated purchase probabilities.

Here, the product purchase probability may be any one of the highest purchase probability, among the multiple purchase probabilities corresponding to the multiple subsequences, the average value of the multiple purchase probabilities, and the median value of the multiple purchase probabilities.

Here, the first number of detections, indicating the number of times that each of the multiple subsequences is detected from a purchase pattern corresponding to the purchase probability model, and the second number of detections, indicating the number of times that each of the multiple subsequences is detected from a non-purchase pattern corresponding to the purchase probability model, may be extracted. That is, the first number of detections may be the number of times that a specific subsequence is detected from the purchase pattern corresponding to the purchase probability model, and the second number of detections may be the number of times that a specific subsequence is detected from the non-purchase pattern corresponding to the purchase probability model.

For example, it may be assumed that (1, 2, 3) and (1, 3) are included as purchase patterns in the purchase probability model, that (1, 2, 4) is included as a non-purchase pattern in the purchase probability model, and that a URI sequence depending on the online behavior of the user corresponds to 1, 2, 3, and 4. In this case, the first number of detections and the second number of detections may be extracted for each of subsequences, that is, (1), (1, 2), (1, 2, 3), (1, 2, 3, 4), (2), (2, 3), (2, 3, 4), (3), (3, 4), and (4). Since the subsequence (1) is detected from all purchase patterns of the purchase probability model, the first number of detections may be 2. Further, since the subsequence (1) is also detected from the non-purchase pattern, the second number of detections may be 1. Since the subsequence (1, 2) is individually detected from the purchase pattern (1, 2, 3) and the non-purchase pattern (1, 2, 4), both the first number of detections and the second number of detections may be 1. Through this scheme, the first number of detections and the second number of detections may be extracted for all subsequences.

Here, the first number of detections is divided by the sum of the first number of detections and the second number of detections, and thus the purchase probabilities respectively corresponding to the multiple subsequences may be calculated.

In the above example, for the subsequence (1), the first number of detections is 2, and the second number of detections is 1, and thus the purchase probability of the subsequence (1) may be calculated as 2/(2+1)=0.67, that is, 67%. In the above example, for the subsequence (1, 2), both the first number of detections and the second number of detections is 1, and thus the purchase probability of the subsequence (1, 2) may be calculated as 1/(1+1)=0.5, that is, 50%.

In this case, it is possible to calculate purchase probabilities for all subsequences that can be derived from the URI sequence and decide on the product purchase probability using the purchase probabilities. However, a large load may be imposed on the server due to a calculation procedure or processing procedure for calculating purchase probabilities for all subsequences. Therefore, the product purchase probability may be calculated by effectively deriving only some subsequences from the URI sequence using the preset reference length, the preset reference time, the preset maximum length, and the preset maximum time, thus reducing the amount of load imposed on the server.

When time elapses in the state in which additional online behavior does not occur, the product purchase probability may be decreased as the elapsed time increases.

For example, assuming that the time required for the product purchase probability to decrease from 100% to 0% is t, a decrement is calculated to be gradually increased as time elapses, as given by the following Equation (1), thus enabling the product purchase probability to be adjusted.

(adjusted product purchase probability)=(calculated product purchase probability*Math.sqrt (t−elapsed time)/Math.sqrt(t) (1)

Here, Math.sqrt(x) may be the square root of x, and the elapsed time may be used as a value identical to time t when the elapsed time of the user is equal to or greater than time t.

Further, as time elapses, the product purchase probability may be designated to be decreased to a certain level.

Also, referring to FIG. 2, the purchase probability prediction method according to the embodiment of the present invention updates the purchase probability model using the URI sequence and the purchase results of the user at step S240 when the behavior cycle of the user for the shopping site ends at step S235.

Here, a sequence from the start to end of the online behavior of the user in the shopping site may be referred to as a “single behavior cycle”.

The purchase probability model may be updated based on information collected at intervals of a predetermined time, or may be updated when the number of behavior cycles that are not reflected in the model and are collected is greater than a predetermined number or more, or whenever a new behavior cycle is created.

For example, when a URI sequence is given by a new user, the purchase probability model may be updated using both the product purchase probability for the URI sequence and information about whether the user actually purchased a product.

Here, only URI sequences having the same level may be collected to create a separate purchase probability model even when the purchase probability model is updated or learned, in the same way as the scheme for differently setting category levels in consideration of application of service or for generating a URI sequence on a product basis when the URI sequence for the user is generated.

The time point of the end of the behavior cycle may be determined based on any one of a time point at which the user logs out from the shopping site and a time point at which the user leaves the shopping site.

That is, upon determining the end of the behavior cycle on an access-session basis, it may be determined that the behavior cycle has ended depending on a period from a time point at which the user newly accesses the shopping site to a time point at which the purchase has been completed or depending on the case where the user declares an explicit termination, such as a logout. Also, a period from the new access to the shopping site by the user to a time point at which the user leaves the shopping site, as in the case of the termination of a browser or an application, may be decided on as a single behavior cycle.

However, in the case of the termination of the browser or application, there are many cases where it is difficult to explicitly receive logs, and thus it may be determined that the behavior cycle has ended when the user does not show any online behavior until a predetermined time elapses from the last online action.

In this way, when the behavior cycle is determined on the access-session basis, this scheme may be more suitable for an application service that utilizes the user's short-term interest. In an application service in which there is a need to maintain the user's interest for a long term in consideration of shopping continuity or the like, the behavior cycle may be implemented such that the period of the behavior cycle is lengthened to one day, one week, one month, or the like.

The end of the behavior cycle may mean that whether a sequence for each user is terminated in a purchase or a non-purchase may be determined. Based on this, the update may be performed by distinguishing an update depending on a purchase pattern from an update depending on a non-purchase pattern when the purchase probability model is updated.

Further, although not illustrated in FIG. 2, the purchase probability prediction method according to the embodiment of the present invention may store various types of information generated during the above-described purchase probability prediction process in a separate storage module.

Through the use of the purchase probability prediction method, the current purchase intention of a customer may be more accurately detected, and thus information about a product currently of interest to the customer may be provided.

Further, the timeliness and accuracy of a product to be provided as marketing information to customers may be improved by calculating, in real time, the probability of interest of each customer in a specific product or a specific category.

Furthermore, industrially useful information may be provided by quantitatively indicating the probability that a user who visits an online shopping site will purchase a product and information about each user who takes interest in the corresponding product or category in the shopping site.

In addition, a conventional “cold start” problem in which it has been impossible to perform prediction for a new user due to the absence of base data may be solved.

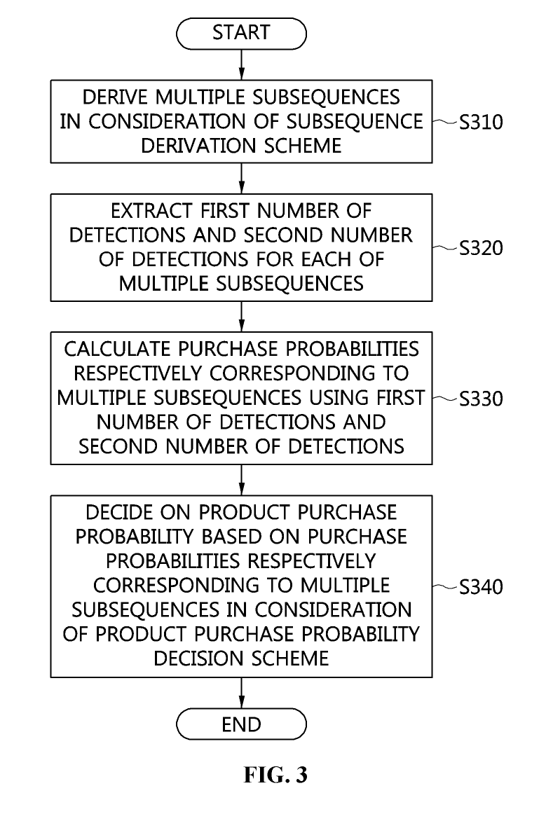

FIG. 3 is an operation flowchart illustrating an example of a procedure for deciding on a product purchase probability by deriving subsequences of a URI sequence in the purchase probability prediction method according to the present invention.

Referring to FIG. 3, the procedure for deciding on a product purchase probability by deriving subsequences of a URI sequence in the purchase probability prediction method according to the present invention derives multiple subsequences in consideration of a scheme for deriving subsequences at step S310.

Here, schemes for deriving subsequences from the URI sequence may be chiefly classified into a scheme for deriving subsequences by dividing the URI sequence by a preset reference length or a preset reference time and a scheme for extracting a number of URIs corresponding to the preset maximum length or the preset maximum time so that the last URI included in the URI sequence is extracted first, and then deriving subsequences corresponding to the extracted URIs.

Here, the preset reference length may be the number of URIs.

For example, when the preset reference length is 3 and the URI sequence corresponds to 1, 2, 3, 4, 5, and 6, the URI sequence may be divided into multiple division sequences respectively corresponding to (1, 2, 3), (2, 3, 4), (3, 4, 5), and (4, 5, 6), and subsequences may be derived from each of the division sequences. That is, in the same way as the method for deriving subsequences (1), (1, 2), (1, 2, 3), (2), (2, 3), and (3) from the division sequence (1, 2, 3), subsequences may be derived from the remaining division sequences (2, 3, 4), (3, 4, 5), and (4, 5, 6).

Here, the preset reference time may be a predetermined time unit.

For example, assuming that the preset reference time is 1 minute and that the URI sequence corresponds to 1, 2, 3, 4, 5, and 6, URIs which are collected during a period of one minute from the time at which a first URI corresponding to the URI sequence, that is, a URI No. 1, appears may be aggregated together to generate a single division sequence. That is, assuming that the time at which the URI No. 1 appears is n, URIs appearing during a period from minute n to minute n+1 may be aggregated together to generate a single division sequence, and then subsequences may be derived from the division sequence. Further, URIs appearing during a period from minute n+1 to minute n+2 may be aggregated together to generate an additional division sequence, and then subsequences may be derived from the division sequence. In this way, the above procedure may be repeated to perform division until all URIs included in the URI sequence are included in division sequences.

Here, the most recent URI, among the multiple URIs included in the URI sequence, may be a URI included in the last sequential position in the order of arrangement. Therefore, a number of URIs, corresponding to the preset maximum length or to the preset maximum time and arranged successively from the last URI included in the URI sequence, may be extracted, and then subsequences for the URIs may be derived.

For example, assuming that the URI sequence corresponds to 1, 2, 3, 4, 5, 6, 7, and 8, and that the present maximum length is 4, a sequence is derived to correspond to (5, 6, 7, 8), indicating four URIs from 8, which is the last URI of the URI sequence. Also, (5), (5, 6), (5, 6, 7), (5, 6, 7, 8), (6), (6, 7), (6, 7, 8), (7), (7, 8), and (8) may be derived as subsequences from (5, 6, 7, 8).

In another example, assuming that the URI sequence corresponds to 1, 2, 3, 4, 5, 6, 7, and 8 and that the preset maximum time is 1 minute, URIs appearing during a period from time n at which an URI No. 8, the last URI in the URI sequence, appears to time n−1 may be extracted, and subsequences may be derived from a sequence composed of the extracted URIs.

Thereafter, the first number of detections and the second number of detections are extracted for each of the multiple subsequences at step S320.

The first number of detections may be the number of times that a specific subsequence is detected from a purchase pattern corresponding to the purchase probability model, and the second number of detections may be the number of times that a specific subsequence is detected from a non-purchase pattern corresponding to the purchase probability model.

Thereafter, purchase probabilities respectively corresponding to the multiple subsequences are calculated using the first number of detections and the second number of detections at step S330.

Here, the first number of detections is divided by the sum of the first number of detections and the second number of detections, and thus the purchase probabilities respectively corresponding to the multiple subsequences may be calculated.

Next, a product purchase probability is decided on based on the purchase probabilities respectively corresponding to the multiple subsequences in consideration of the scheme for deciding on the product purchase probability at step S340.

Here, the product purchase probability may be finally decided on as any one of the highest purchase probability, among the multiple purchase probabilities corresponding to the multiple subsequences, the average value of the multiple purchase probabilities, and the median value of the multiple purchase probabilities.

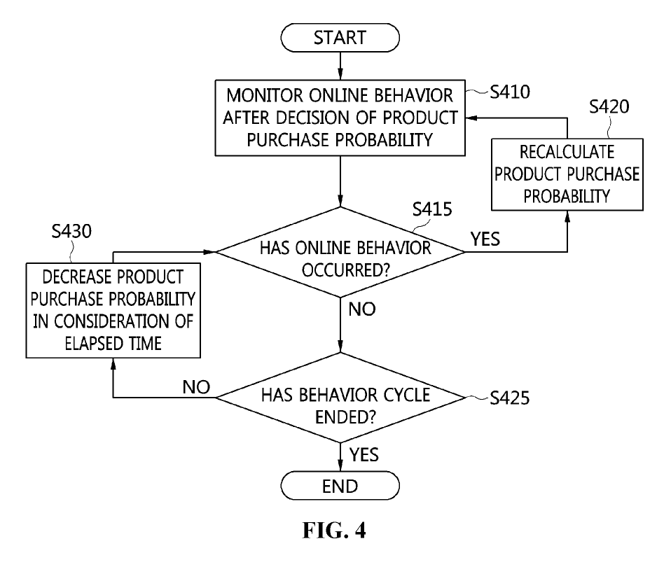

FIG. 4 is an operation flowchart illustrating an example of a procedure for decreasing a product purchase probability in consideration of elapsed time depending on online behavior in the purchase probability prediction method according to the present invention.

Referring to FIG. 4, the procedure for decreasing a product purchase probability in consideration of elapsed time depending on online behavior in the purchase probability prediction method according to the present invention may monitor the online behavior of a user after a product purchase probability has been decided on at step S410.

Here, the purpose of monitoring may be intended to check whether additional online behavior has occurred in addition to the online behavior (actions) of the user collected to calculate the product purchase probability.

Thereafter, whether additional online behavior of the user has occurred may be determined at step S415.

That is, it may be determined whether the additional online behavior has occurred, after the last online action shown by the user, among online actions of the user collected to calculate the product purchase probability.

If it is determined at step S415 that additional online behavior has occurred, the product purchase probability may be recalculated based on the additionally shown online behavior at step S420.

In contrast, if it is determined at step S415 that any additional online behavior has not occurred, whether a behavior cycle has ended may be determined at step S425.

Here, the time point of the end of the behavior cycle may be any one of a time point at which the user logs out from the corresponding shopping site and a time point at which the user leaves the shopping site.

If it is determined at step S425 that the behavior cycle has not ended, the product purchase probability may be decreased in consideration of the time elapsed from the last online action shown by the user at step S430.

As the elapsed time increases, the product purchase probability calculated to correspond to the user may also be greatly decreased.

In contrast, if it is determined at step S425 that the behavior cycle has ended, the procedure for calculating the product purchase probability may be terminated.

FIG. 5 is a diagram illustrating an example of log arrangement results according to the present invention.

Referring to FIG. 5, log arrangement results 500 in which logs are arranged in real time according to an embodiment of the present invention may include information related to a timestamp field 501, a user ID field 502, a user terminal ID field 503, a URI field 504, a product number field 505, and category fields 506, 507, and 508.

The timestamp field 501 may indicate the time at which the corresponding log is generated.

The user ID field 502 may indicate an identifier for identifying a user in a shopping site or an e-commerce site. For example, when the user subscribes to the shopping site, the user ID may be an ID registered at the time of subscribing to the shopping site, whereas when the user does not subscribe to the shopping site, the user ID may be an identifier generated based on the user's access information.

The user terminal ID field 503 may indicate an identifier for identifying a user terminal that is used when the user accesses the corresponding shopping site.

The URI field 504 may indicate the page of the shopping site accessed by the user.

For example, ‘MW/Product/Detail’ illustrated in FIG. 5 may be a page containing details of each product, ‘MW/Basket’ may be a shopping cart page, and ‘MW/Pay’ may be a payment page.

The product number field 505 may indicate an identification number or an identifier for identifying a product corresponding to the current page accessed by the user.

The category fields 506, 507, and 508 may indicate category information about the product corresponding to the product number field 505.

As illustrated in FIG. 5, category information may be included in logs so that products are sorted into respective category levels.

For example, the first category field 506 illustrated in FIG. 5 may indicate the field of a product such as ‘camera’, and may indicate a category that is conceptually more inclusive than that of the second category field 507, indicating the detailed category of the product, such as ‘camera type’. The second category field 507 may indicate a category that is conceptually more inclusive than that of the third category field 508, indicating detailed information of the product such as ‘camera brand’.

In this case, the logs according to an embodiment of the present invention may be collected so as to include various types of information in addition to the above examples, and the type of included information is not particularly limited.

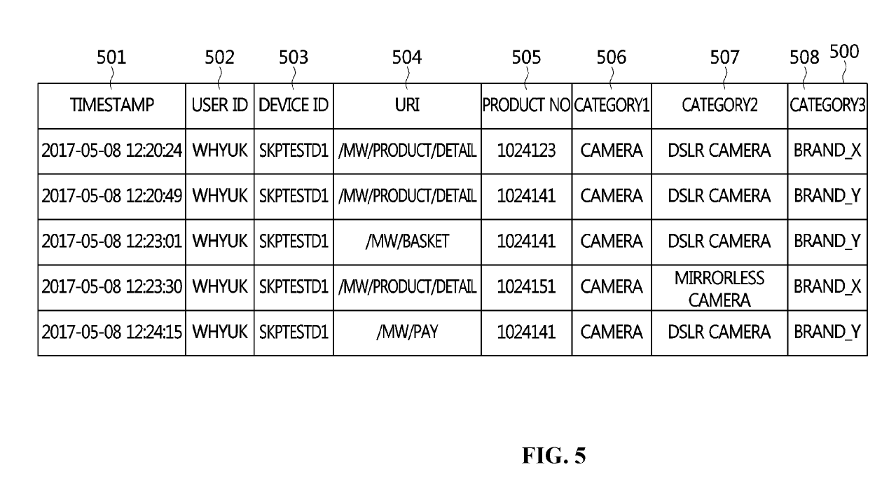

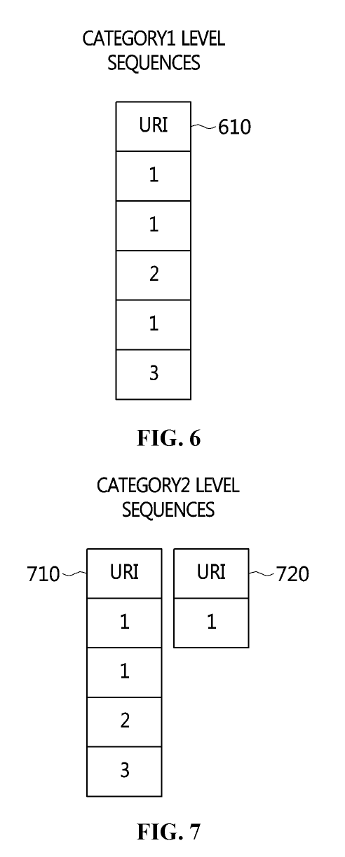

FIGS. 6 to 9 are diagrams illustrating examples of URI sequences derived from the log arrangement results illustrated in FIG. 5.

Referring to FIG. 6, it can be seen that a URI sequence 610 generated based on the first category field 506, among the category fields illustrated in FIG. 5, is generated to correspond to (1, 1, 2, 1, 3).

Here, URIs 1, 2, and 3 constituting the URI sequence 610 may be simplified forms of ‘/MW/Product/Detail’, ‘/MW/Basket’, and ‘/MW/Pay’, respectively, illustrated in the URI 504 of FIG. 5.

That is, in the log arrangement results 500 illustrated in FIG. 5, products in the first category field 506 equally indicate ‘Camera’, and thus the URI sequence 610 may be generated to correspond to (1, 1, 2, 1, 3) by sequentially extracting URIs from all logs.

Referring to FIG. 7, it can be seen that a URI sequence 710 and a URI sequence 720, which are generated based on the second category field 507, among the categories illustrated in FIG. 5, are generated to correspond to (1, 1, 2, 3) and (1), respectively.

Here, since the second category field 507 is classified into ‘DSLR Camera’ and ‘Mirrorless Camera’ in the log arrangement results 500 illustrated in FIG. 5, URIs may also be extracted by separating ‘DSLR Camera’ and ‘Mirrorless Camera’.

That is, in the case of ‘DSLR Camera’, the URI sequence may be generated to correspond to (1, 1, 2, 3) by sequentially extracting URIs from four logs, among the five logs arranged in FIG. 5. Further, since ‘Mirrorless Camera’ corresponds to only one of the five logs arranged in FIG. 5, the URI sequence may be generated to correspond to (1) by extracting the one URI.

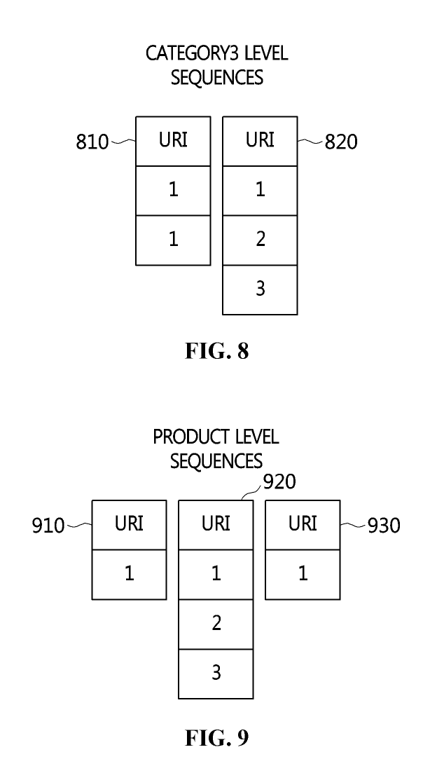

Referring to FIG. 8, it can be seen that a URI sequence 810 and a URI sequence 820, which are generated based on the third category 508, among the categories illustrated in FIG. 5, are generated to correspond to (1, 1) and (1, 2, 3), respectively.

Since the third category field 508 is classified into ‘Brand_X’ and ‘Brand_Y’ in the log arrangement results 500 illustrated in FIG. 5, URIs may also be extracted by separating ‘Brand_X’ and ‘Brand_Y’.

That is, in the case of ‘Brand_X’, the URI sequence may be generated to correspond to (1, 1) by sequentially extracting URIs from two logs, among the five logs arranged in FIG. 5. In the case of ‘Brand_Y’, the URI sequence may be generated to correspond to (1, 2, 3) by sequentially extracting URIs from three logs, among the five logs arranged in FIG. 5.

Referring to FIG. 9, it can be seen that a URI sequence 910, a URI sequence 920, and a URI sequence 930, which are generated based on the product number field 505 illustrated in FIG. 5, are generated to correspond to (1), (1, 2, 3), and (1), respectively.

Here, since the product number field 505 is classified into three products corresponding to ‘1024123’, ‘1024141’, and ‘1024151’ in the log arrangement results 500 of FIG. 5, URIs may be extracted by separating the three products.

That is, the URI sequence corresponding to ‘1024123’ may be generated to correspond to (1) by extracting a URI from one log, the URI sequence corresponding to ‘1024141’ may be generated to correspond to (1, 2, 3) by sequentially extracting URIs from three logs, and the URI sequence corresponding to ‘1024151’ may be generated to correspond to (1) by extracting a URI from one log.

In this way, as illustrated in FIGS. 6 to 9, URI sequences are generated in conformity with different bases depending on an application service in which the product purchase probability is to be utilized according to an embodiment of the present invention, and thus more accurate and suitable results may be provided when each application service is utilized.

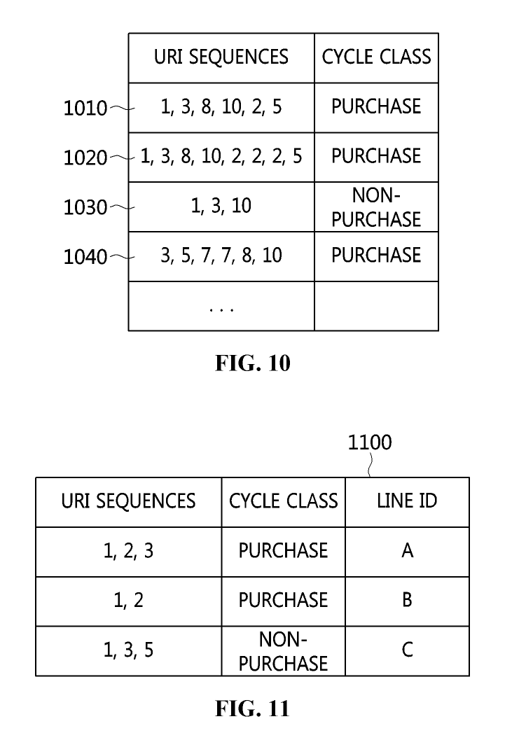

FIG. 10 is a diagram illustrating examples of purchase results and URI sequences at a time point at which a behavior cycle according to the present invention ends.

Referring to FIG. 10, at the time point at which the behavior cycle according to the present invention ends, actual purchase results may match respective URI sequences 1010, 1020, 1030, and 1040 generated in respective behavior cycles.

Here, the actual purchase results may be acquired from the purchase results in the corresponding shopping site, and purchase results matching the respective URI sequences 1010, 1020, 1030, and 1040 may be utilized to update a purchase probability model for the corresponding shopping site.

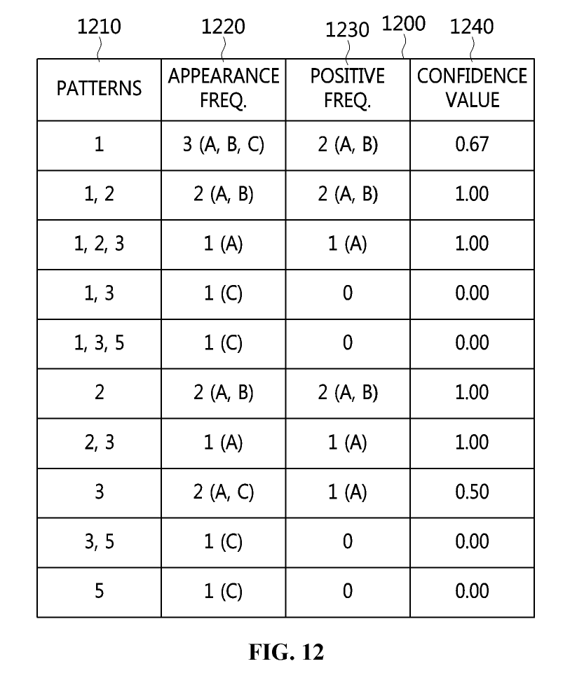

FIGS. 11 and 12 are diagrams illustrating examples of a procedure for creating a purchase probability model based on URI sequences.

Referring to FIGS. 11 and 12, a purchase probability model 1200 according to an embodiment of the present invention may be created based on sequence-based purchase information 1100 corresponding to URI sequences derived from the corresponding shopping site.

For example, it may be assumed that logs are collected from a shopping site for which a product purchase probability is desired to be calculated, and then the sequence-based purchase information 1100, such as that shown in FIG. 11, is generated. That is, for line ID A, in which a URI sequence corresponds to (1, 2, 3), and for line ID B, in which a URI sequence corresponds to (1, 2), a purchase is made, and for line ID C, in which a URI sequence corresponds to (1, 3, 5), a purchase is not made.

In this case, in order to create a purchase probability model 1200 such as that shown in FIG. 12, using the sequence-based purchase information 1100 such as that shown in FIG. 11, all subsequences may be derived first from each URI sequence included in the sequence-based purchase information 1100.

For example, in the case of sequence A, subsequences corresponding to (1), (1, 2), (1, 2, 3), (2), (2, 3), and (3) may be derived. Further, in the case of sequence B, subsequences corresponding to (1), (1, 2), and (2) may be derived. In addition, in the case of sequence C, subsequences corresponding to (1), (1, 3), (1, 3, 5), (3), (3, 5), and (5) may be derived. When overlapping subsequence are deleted from the derived subsequences and the remaining subsequences are arranged, the resulting sequence patterns may be indicated in sequence patterns 1210 illustrated in FIG. 12.

Thereafter, the number of times that each pattern arranged in the sequence patterns 1210 is detected from all URI sequences included in the sequence-based purchase information 1100 may be checked, and the total number of detections (i.e. total appearance frequency) 1220 may be input.

In an example, since pattern (1) is detected from all URI sequences included in the sequence-based purchase information 1100, ‘3’ may be input as the total appearance frequency 1220.

In another example, since pattern (1, 2) is detected only in A and B, among the URI sequences included in the sequence-based purchase information 1100, ‘2’ may be input to the total appearance frequency 1220.

After the total appearance frequencies 1220 have been input for all patterns arranged in the sequence patterns 1210 through this method, the number of purchase pattern detections (i.e. positive frequency) 1230 may be input for all patterns arranged in the sequence patterns 1210.

In this case, the number of purchase pattern detections 1230 may indicate the number of times that each of the patterns arranged in the sequence patterns 1210 is detected from a URI sequence corresponding to a purchase, among the URI sequences included in the sequence-based purchase information 1100.

In an example, since pattern (2) is detected from URI sequences A and B corresponding to a purchase, which are included in the sequence-based purchase information 1100, ‘2’ may be input as the number of purchase pattern detections (positive frequency) 1230.

In another example, since pattern (5) is not detected from the URI sequences corresponding to a purchase, which are included in the sequence-based purchase information 1100, ‘0’ may be input as the number of purchase pattern detections (positive frequency) 1230.

Thereafter, the reliability (i.e. confidence value) 1240 of the purchase probability model 1200 illustrated in FIG. 12 may be a value obtained by dividing the number of purchase pattern detections (positive frequency) 1230 input for each pattern by the total number of detections (total appearance frequency) 1220.

In an example, the confidence value 1240 of the pattern (1, 2) may be 1, which is a value obtained by dividing 2, which is the number of purchase pattern detections 1230, by 2, which is the total number of detections 1220.

In another example, the confidence value 1240 of the pattern (1, 3, 5) may be 0, which is a value obtained by dividing 0, which is the number of purchase pattern detections 1230, by 1, which is the total number of detections 1220.

At this time, the confidence value 1240 may be the purchase probability corresponding to each of the arranged patterns.

For example, all of the purchase probabilities of the patterns (1, 2), (1, 2, 3), (2), and (2, 3) may be 100%, obtained by representing a confidence value of 1 as percentages. Further, the purchase probability of the pattern (1) may be 67%, obtained by representing a confidence value of 0.67 as percentages, and the purchase probability of the pattern (3) may be 50%. In addition, the purchase probabilities of all remaining patterns (1, 3), (1, 3, 5), (3, 5), and (5) may be 0%.

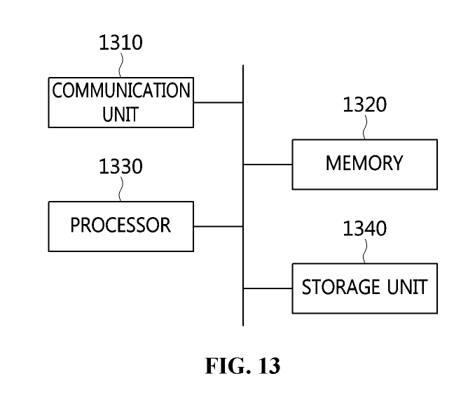

FIG. 13 is a block diagram illustrating a server for predicting a purchase probability according to an embodiment of the present invention.

Referring to FIG. 13, the server for predicting a purchase probability according to the embodiment of the present invention may include a communication unit 1310, memory 1320, a processor 1330, and a storage unit 1340.

The communication unit 1310 functions to transmit/receive information needed to predict a purchase probability over a communication network, such as a typical network. In particular, the communication unit 1310 according to the embodiment of the present invention may receive real-time logs for the online behavior of a user from an online shopping server or other terminals.

The memory 1320 stores logs collected in real time for the user who accesses a shopping site.

The collected logs may be data about all online behavior of the user when visiting an online shopping site or an e-commerce site and which is related to shopping.

For example, the online behavior may include relatively explicit actions such as the actions of clicking a product, reading product reviews, addition to or deletion from a shopping cart, attempting to make a payment, entering a keyword, clicking an advertisement, and the social activity of clicking the “like” button or sharing a specific page. Further, the online behavior may also include all implicit actions considered to have a possibility of forming a basis for inferring products of interest, such as user experience (UX)-related actions including a mouse wheel control or swipe-out action, or the action of staying on a specific page for a long period of time or revisiting the same product page or a similar category page. However, the online actions are not limited to those examples.

Therefore, all actions taken by the user who accesses the shopping site may be acquired in the form of logs in real time.

Here, the server according to the embodiment of the present invention may utilize the above-described real-time online behavior of the user. That is, unlike a conventional scheme, in which a purchase product is recommended or a purchase probability is predicted using the past purchase records or profile information of the user, the present invention may infer a product or category having a strong possibility of being purchased by the user before long, based on a behavior pattern such as which page is currently being visited by the user within the shopping site currently accessed by the user. By means of this scheme, it is possible to more accurately detect the user's current purchase intention.

Here, the logs collected in real time may include the time at which each online action occurs, an ID for identifying the user or the user terminal, an accessed URI, product-related information, etc. In this case, the product-related information included in the logs may include only a product number enabling the type of product to be identified, but category information mapped to a product corresponding to the product number may be acquired based on additional memory or an additional database (DB). Further, the product-related information may also include product-related meta-information, such as a product price or option, by which the degree of importance of online behavior can be determined.

The number of paths through which logs are collected in real time may not be limited to one. For example, logs related to the online behavior of the user may be collected in real time through any of various paths, such as a mobile website, a mobile application, and a PC website.

In addition, the logs may be received in such a way that the server according to the embodiment of the present invention unifies and receives all logs, or in such a way that the server receives a simplified form of logs aggregated by some terminals. Here, the method for receiving logs is not particularly limited to a specific method.

The processor 1330 generates a Uniform Resource Identifier (URI) sequence corresponding to the online behavior of the user by arranging the logs in temporal sequence, and calculates the product purchase probability of the user by comparing the URI sequence with a purchase probability model corresponding to the shopping site.

First, the processor 1330 generates a Uniform Resource Identifier (URI) sequence corresponding to the online behavior of the user by arranging the logs in temporal sequence.

When logs for various online actions are collected without identifying users in a specific shopping site, the logs may be classified for respective users, after which the logs may be arranged in temporal sequence.

In this case, the purchase probability prediction method according to the present invention may arrange the logs by adjusting the URI sequence to various levels depending on the product purchase probability of the user, that is, the purpose for using interest information related to a purchase.

In an example, in order to utilize purchase-interest information for each product, the collected logs may be arranged to be aggregated together for respective products.

In another example, in order to utilize purchase-interest information for each product category, the collected logs may be arranged to be aggregated together for respective categories.

Here, respective URIs constituting the URI sequence may be converted into and represented by separate IDs to simplify processing.

For example, in the URI sequence in which URIs are arranged for respective products, a URI corresponding to a product detail page, that is, ‘/Product/Detail’, may be represented by No. 1, a URI corresponding to a shopping cart page, that is, ‘Basket’, may be represented by No. 2, and a URI corresponding to a product payment page, that is, ‘/Pay’, may be represented by No. 3. That is, assuming that the user adds a product to the shopping cart in the product detail page, and thereafter goes to a payment page through the shopping cart page, the URI sequence may be represented by (1, 2, 3).

Here, when a new URI is added to the shopping site due to an external factor, such as the update or renewal of the shopping site, an ID may also be assigned to and used in the added URI.

Each URI may be converted into a short character string using a hashing technique, and the converted character string may also be used as an ID corresponding to the URI.

Here, the URI sequence may be maintained and may then be deleted based on a session, a logout time point, a purchase time point, a time limitation, or the like, according to the service policy that utilizes a product purchase probability. That is, the purchase probability prediction method according to the embodiment of the present invention is intended to detect a product currently of interest to the user who accesses the shopping site and use the product currently of interest for a marketing service, such as the recommendation of a product or the provision of a coupon, and thus there is no need to maintain the generated URI sequence after the user has terminated online behavior in the shopping site. Therefore, to manage at least the memory storage capacity of the server, the URI sequence, the use of which has been completed, may be deleted.

Next, the processor 1330 calculates the product purchase probability of the user by comparing the URI sequence with a purchase probability model corresponding to the shopping site.

Here, the purchase probability model may be a purchase probability model for the corresponding shopping site. That is, the purchase probability model may be created as a result of deriving all subsequences, that is, all patterns, from each URI sequence collected from the corresponding shopping site, and of applying an association rule to the subsequences using the frequency at which each subsequence appears in a purchase pattern or a non-purchase pattern.

For example, a purchase pattern or a non-purchase pattern may be extracted and included in the purchase probability model, based on a URI sequence which frequently appears when a purchase is made by multiple users who use the corresponding shopping site, or a URI sequence which frequently appears when a purchase is not made by users. Here, a URI sequence, for which the total number of appearances (hereinafter also referred to as “total appearance frequency”) in each pattern does not reach a predetermined number, may be excluded, and thus computing speed at which the purchase probability model is created may be improved.

Therefore, the URI sequence corresponding to the user is compared with the purchase pattern or the non-purchase pattern included in the purchase probability model, and thus whether the user will purchase a product may be calculated in the form of a probability.

At this time, multiple subsequences, each having a length of at least 1, may be generated by extracting multiple URIs constituting the URI sequence so that the multiple URIs are temporally adjacent to each other.

For example, when a URI sequence corresponding to the user is generated to correspond to 1, 2, and 3, six subsequences corresponding to (1), (1, 2), (1, 2, 3), (2), (2, 3), and (3) may be generated. That is, the case of (1, 3), in which URIs are not adjacent to each other, is not derived as a subsequence.

In another example, when a URI sequence corresponding to the user is generated to correspond to 2, 3, 5, and 8, ten subsequences, corresponding to (2), (2, 3), (2, 3, 5), (2, 3, 5, 8), (3), (3, 5), (3, 5, 8), (5), (5, 8), and (8), may be generated. Similarly, the cases of (2, 5), (2, 8), (3, 8), (2, 3, 8), and (2, 5, 8), in which URIs are not adjacent to each other, are not derived as subsequences.

Here, based on any one of a preset reference length and a preset reference time, the URI sequence may be divided into multiple division sequences, and multiple subsequences may be derived from each of the multiple division sequences.

The preset reference length may be the number of URIs.

For example, when the preset reference length is 3 and the URI sequence corresponds to 1, 2, 3, 4, 5, and 6, the URI sequence may be divided into multiple division sequences respectively corresponding to (1, 2, 3), (2, 3, 4), (3, 4, 5), and (4, 5, 6), and subsequences may be derived from each of the division sequences. That is, in the same way as the method for deriving subsequences (1), (1, 2), (1, 2, 3), (2), (2, 3), and (3) from the division sequence (1, 2, 3), subsequences may be derived from the remaining division sequences (2, 3, 4), (3, 4, 5), and (4, 5, 6).

Here, the preset reference time may be a predetermined time unit.

For example, assuming that the preset reference time is 1 minute and that the URI sequence corresponds to 1, 2, 3, 4, 5, and 6, URIs which are collected during a period of one minute from the time at which a first URI corresponding to the URI sequence, that is, a URI No. 1, appears may be aggregated together to generate a single division sequence. That is, assuming that the time at which the URI No. 1 appears is n, URIs appearing during a period from minute n to minute n+1 may be aggregated together to generate a single division sequence, and then subsequences may be derived from the division sequence. Further, URIs appearing during a period from minute n+1 to minute n+2 may be aggregated together to generate an additional division sequence, and then subsequences may be derived from the division sequence. In this way, the above procedure may be repeated to perform division until all URIs included in the URI sequence are included in division sequences.

Here, at least one URI corresponding to any one of a preset maximum length and a preset maximum time may be extracted from the multiple URIs so that the most recent URI is extracted first in consideration of temporal sequence, and multiple subsequences may be derived from the sequence corresponding to the at least one URI.

Here, the most recent URI, among the multiple URIs included in the URI sequence, may be a URI included in the last sequential position in the order of arrangement. Therefore, a number of URIs, corresponding to the preset maximum length or to the preset maximum time and arranged successively from the last URI included in the URI sequence, may be extracted, and then subsequences for the URIs may be derived.

For example, assuming that the URI sequence corresponds to 1, 2, 3, 4, 5, 6, 7, and 8, and that the present maximum length is 4, a sequence is derived to correspond to (5, 6, 7, 8), indicating four URIs from 8, which is the last URI of the URI sequence. Also, (5), (5, 6), (5, 6, 7), (5, 6, 7, 8), (6), (6, 7), (6, 7, 8), (7), (7, 8), and (8) may be derived as subsequences from (5, 6, 7, 8).

In another example, assuming that the URI sequence corresponds to 1, 2, 3, 4, 5, 6, 7, and 8 and that the preset maximum time is 1 minute, URIs appearing during a period from time n at which an URI No. 8, the last URI in the URI sequence, appears to time n−1 may be extracted, and subsequences may be derived from a sequence composed of the extracted URIs.

Here, purchase probabilities respectively corresponding to multiple subsequences may be calculated based on the purchase probability model, and a product purchase probability may be decided on based on the purchase probabilities respectively corresponding to the multiple subsequences.

Here, the purchase probabilities respectively corresponding to the multiple subsequences may be probabilities that the user will purchase a product when acting depending on patterns corresponding to respective subsequences. That is, when the URI sequence corresponds to 1, 2, and 3, purchase probabilities may be calculated for respective subsequences corresponding to (1), (1, 2), (1, 2, 3), (2), (2, 3), and (3), and the product purchase probability may be finally decided on using the calculated purchase probabilities.

Here, the product purchase probability may be any one of the highest purchase probability, among the multiple purchase probabilities corresponding to the multiple subsequences, the average value of the multiple purchase probabilities, and the median value of the multiple purchase probabilities.

Here, the first number of detections, indicating the number of times that each of the multiple subsequences is detected from a purchase pattern corresponding to the purchase probability model, and the second number of detections, indicating the number of times that each of the multiple subsequences is detected from a non-purchase pattern corresponding to the purchase probability model, may be extracted. That is, the first number of detections may be the number of times that a specific subsequence is detected from the purchase pattern corresponding to the purchase probability model, and the second number of detections may be the number of times that a specific subsequence is detected from the non-purchase pattern corresponding to the purchase probability model.

For example, it may be assumed that (1, 2, 3) and (1, 3) are included as purchase patterns in the purchase probability model, that (1, 2, 4) is included as a non-purchase pattern in the purchase probability model, and that a URI sequence depending on the online behavior of the user corresponds to 1, 2, 3, and 4. In this case, the first number of detections and the second number of detections may be extracted for each of subsequences, that is, (1), (1, 2), (1, 2, 3), (1, 2, 3, 4), (2), (2, 3), (2, 3, 4), (3), (3, 4), and (4). Since the subsequence (1) is detected from all purchase patterns of the purchase probability model, the first number of detections may be 2. Further, since the subsequence (1) is also detected from the non-purchase pattern, the second number of detections may be 1. Since the subsequence (1, 2) is individually detected from the purchase pattern (1, 2, 3) and the non-purchase pattern (1, 2, 4), both the first number of detections and the second number of detections may be 1. Through this scheme, the first number of detections and the second number of detections may be extracted for all subsequences.

Here, the first number of detections is divided by the sum of the first number of detections and the second number of detections, and thus the purchase probabilities respectively corresponding to the multiple subsequences may be calculated.

In the above example, for the subsequence (1), the first number of detections is 2, and the second number of detections is 1, and thus the purchase probability of the subsequence (1) may be calculated as 2/(2+1)=0.67, that is, 67%. In the above example, for the subsequence (1, 2), both the first number of detections and the second number of detections is 1, and thus the purchase probability of the subsequence (1, 2) may be calculated as 1/(1+1)=0.5, that is, 50%.

In this case, it is possible to calculate purchase probabilities for all subsequences that can be derived from the URI sequence and decide on the product purchase probability using the purchase probabilities. However, a large load may be imposed on the server due to a calculation procedure or processing procedure for calculating purchase probabilities for all subsequences. Therefore, the product purchase probability may be calculated by effectively deriving only some subsequences from the URI sequence using the preset reference length, the preset reference time, the preset maximum length, and the preset maximum time, thus reducing the amount of load imposed on the server.

When time elapses in the state in which additional online behavior does not occur, the product purchase probability may be decreased as the elapsed time increases.

For example, assuming that the time required for the product purchase probability to decrease from 100% to 0% is t, a decrement is calculated to be gradually increased as time elapses, as given by the following Equation (1), thus enabling the product purchase probability to be adjusted.

(adjusted product purchase probability)=(calculated product purchase probability*Math.sqrt(t−elapsed time)/Math.sqrt(t) (1)

Here, Math.sqrt(x) may be the square root of x, and the elapsed time may be used as a value identical to time t when the elapsed time of the user is equal to or greater than time t.

Further, as time elapses, the product purchase probability may be designated to be decreased to a certain level.

Next, the processor 1330 updates the purchase probability model using the URI sequence and the purchase results of the user when the behavior cycle of the user for the corresponding shopping site ends.

Here, a sequence from the start to end of the online behavior of the user in the shopping site may be referred to as a “single behavior cycle”.

The purchase probability model may be updated based on information collected at intervals of a predetermined time, or may be updated when the number of behavior cycles that are not reflected in the model and are collected is greater than a predetermined number or more, or whenever a new behavior cycle is created.

For example, when a URI sequence is given by a new user, the purchase probability model may be updated using both the product purchase probability for the URI sequence and information about whether the user actually purchased a product.

Here, only URI sequences having the same level may be collected to create a separate purchase probability model even when the purchase probability model is updated or learned, in the same way as the scheme for differently setting category levels in consideration of application of service or for generating a URI sequence on a product basis when the URI sequence for the user is generated.

The time point of the end of the behavior cycle may be determined based on any one of a time point at which the user logs out from the shopping site and a time point at which the user leaves the shopping site.

That is, upon determining the end of the behavior cycle on an access-session basis, it may be determined that the behavior cycle has ended depending on a period from a time point at which the user newly accesses the shopping site to a time point at which the purchase has been completed or depending on the case where the user declares an explicit termination, such as a logout. Also, a period from the new access to the shopping site by the user to a time point at which the user leaves the shopping site, as in the case of the termination of a browser or an application, may be decided on as a single behavior cycle.

However, in the case of the termination of the browser or application, there are many cases where it is difficult to explicitly receive logs, and thus it may be determined that the behavior cycle has ended when the user does not show any online behavior until a predetermined time elapses from the last online action.

In this way, when the behavior cycle is determined on the access-session basis, this scheme may be more suitable for an application service that utilizes the user's short-term interest. In an application service in which there is a need to maintain the user's interest for a long term in consideration of shopping continuity or the like, the behavior cycle may be implemented such that the period of the behavior cycle is lengthened to one day, one week, one month, or the like.

The end of the behavior cycle may mean that whether a sequence for each user is terminated in a purchase or a non-purchase may be determined. Based on this, the update may be performed by distinguishing an update depending on a purchase pattern from an update depending on a non-purchase pattern when the purchase probability model is updated.

The storage unit 1340 may support functions for predicting a purchase probability according to the embodiment of the present invention, as described above. Here, the storage unit 1340 may act as a separate large-capacity storage, and may include a control function for performing operations.

Meanwhile, the server may store information in memory installed therein. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard disk device, an optical disk device, or any other kind of mass storage.

Through the use of the server, the current purchase intention of a customer may be more accurately detected, and thus information about a product currently of interest to the customer may be provided.

Further, the timeliness and accuracy of a product to be provided as marketing information to customers may be improved by calculating, in real time, the probability of interest of each customer in a specific product or a specific category.

Furthermore, industrially useful information may be provided by quantitatively indicating the probability that a user who visits an online shopping site will purchase a product and information about each user who takes interest in the corresponding product or category in the shopping site.

In addition, a conventional “cold start” problem in which it has been impossible to perform prediction for a new user due to the absence of base data may be solved.

The functional operations and implementations of the subject matter described herein may be implemented as digital electronic circuitry, or may be implemented in computer software, firmware, or hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium in order to control the operation of a processing system or to be executed by the processing system.

The computer-readable medium may be a machine-readable storage device, a machine-readable storage substrate, a memory device, a composition of material that affects a machine-readable radio-wave-type signal or one or more combinations thereof.

As used herein, the terms “system” or “device” include all kinds of apparatuses, devices and machines for processing data, which include, for example, a programmable processor and a computer, or multiple processors and a computer. In addition to hardware, the processing system may also include, for example, code that configures processor firmware, and code that configures an execution environment for computer programs in response to a request from a protocol stack, a database management system, an operating system, or one or more combinations thereof.

A computer program (also known as a program, software, a software application, a script or code) may be written in any form of programming language including a compiled or interpreted language, or an a priori or procedural language, and may be deployed in any form including standalone programs or modules, components, subroutines, or other units suitable for use in a computer environment. The computer program does not necessarily correspond to a file in a file system. The program may be stored in a single file provided to the requested program, in multiple interactive files (for example, files storing one or more modules, subprograms or portions of code), or in a part of a file containing other programs or data (for example, one or more scripts stored in a markup language document). The computer program may be located on a single site or distributed across multiple sites such that it is deployed to run on multiple computers interconnected by a communications network or on a single computer.

The computer-readable medium suitable for storing computer program instructions and data may include, for example, semiconductor memory devices, such as EPROM, EEPROM and flash memory devices, all types of nonvolatile memory, including magnetic disks, such as internal hard disks or external disks, magnetic optical disks, CD-ROMs and DVD-ROMs, media, and memory devices. A processor and memory may be supplemented by special-purpose logic circuits, or may be integrated therewith.

Implementations of the subject matter described herein may be realized on an arithmetic system including, for example, a back-end component such as a data server, a middleware component such as an application server, a front-end component such as a client computer with a web browser or a graphical user interface through which a user may interact with the implementations of the subject matter described herein, or one or more combinations of the back-end component, the middleware component, and the front-end component. The components of the system may be interconnected using any form or medium of digital data communication such as a communication network.

While the present invention includes a number of specific implementation details, they should not be construed as limitations on the scope of the invention or the claimable scope, but should be understood as a description of features that may be specific to particular embodiments of the invention. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may be excluded from the combination in some cases, and the claimed combination may be altered to a sub-combination or variation thereof.

Also, while this specification illustrates operations in the drawings in a particular order, it should not be understood that such operations must be performed in the particular order or the sequential order shown in the drawings in order to obtain a desired result, or that all of the illustrated operations should be performed. In certain cases, multitasking and parallel processing may be advantageous. Also, separation of the various system components of the above-described embodiment should not be understood as requiring such separation in all embodiments, and it should be understood that the program components and systems described above may generally be integrated into a single software product or packaged into multiple software products.

In accordance with the present invention, logs of a user who accesses a shopping site are collected in real time, and are arranged in temporal sequence, and thus a URI sequence corresponding to the online behavior of the user may be generated. The product purchase probability of the user may be calculated by comparing the URI sequence with a purchase probability model corresponding to the shopping site. Further, in accordance with the present invention, quantitative statistical information that can be utilized by a seller who operates an online shopping site may be more accurately provided, and thereby the total volume of business in online shopping may be improved.

In accordance with the present invention, the current purchase intention of a customer may be more accurately detected, and thus information about a product currently of interest to the customer may be provided.

Further, the present invention may improve the timeliness and accuracy of a product to be provided as marketing information to customers by calculating, in real time, the probability of interest of each customer in a specific product or a specific category.

Furthermore, the present invention may provide industrially useful information by quantitatively indicating the probability that a user who visits an online shopping site will purchase a product and information about each user who takes interest in the corresponding product or category in the shopping site.

In addition, the present invention may solve a conventional “cold start” problem in which it has been impossible to perform prediction for a new user due to the absence of base data.

This specification is not intended to limit the present invention to the specific terms disclosed herein. Although the present invention has been described in detail with reference to the above examples, those skilled in the art may conceive alternations, modifications, and variations on these examples without departing from the scope of the present invention. The scope of the present invention is defined by the appended claims rather than the description, and it should be construed that all alternations and modifications derived from the meaning and scope of the appended claims and their equivalents are included within the scope of the present invention.

What is claimed is:

1. A method for predicting a purchase probability, comprising:
collecting, in real time, logs for a user who accesses a shopping site;
generating a Uniform Resource Identifier (URI) sequence corresponding to an online behavior of the user by arranging the logs in temporal sequence; and
calculating a product purchase probability of the user by comparing the URI sequence with a purchase probability model corresponding to the shopping site.

2. The method of claim 1, wherein calculating the product purchase probability comprises:
generating multiple subsequences, each having a length of at least 1, by extracting multiple URIs constituting the URI sequence such that the URIs are temporally adjacent to each other; and
calculating purchase probabilities respectively corresponding to the multiple subsequences based on the purchase probability model and deciding on the product purchase probability based on the purchase probabilities respectively corresponding to the multiple subsequences.

3. The method of claim 2, wherein the product purchase probability is any one of a highest purchase probability, among the multiple purchase probabilities respectively corresponding to the multiple subsequences, an average value of the multiple purchase probabilities, and a median value of the multiple purchase probabilities.

4. The method of claim 2, wherein calculating the product purchase probability further comprises:
extracting a first number of detections that indicates a number of times that each of the multiple subsequences is detected from a purchase pattern corresponding to the purchase probability model, and a second number of detections that indicates a number of times that each of the multiple subsequences is detected from a non-purchase pattern corresponding to the purchase probability model; and
calculating the purchase probabilities respectively corresponding to the multiple subsequences by dividing the first number of detections by a sum of the first number of detections and the second number of detections.

5. The method of claim 2, wherein generating the multiple subsequences is configured to divide the URI sequence into multiple division sequences based on any one of a preset reference length and a preset reference time and to derive the multiple subsequences from each of the multiple division sequences.

6. The method of claim 2, wherein generating the multiple subsequences is configured to extract at least one URI corresponding to any one of a preset maximum length and a preset maximum time from multiple URIs such that a most recent URI is extracted first in consideration of temporal sequence, and to derive the multiple subsequences from a sequence corresponding to the at least one URI.

7. The method of claim 3, wherein calculating the product purchase probability is configured to, when time elapses in a state in which additional online behavior does not occur, decrease the product purchase probability as the elapsed time increases.

8. The method of claim 1, further comprising updating the purchase probability model using the URI sequence and purchase results of the user when a behavior cycle of the user for the shopping site ends.

9. The method of claim 8, wherein updating the purchase probability model is configured to determine a time point of an end of the behavior cycle based on any one of a time point at which the user logs out from the shopping site and a time point at which the user leaves the shopping site.

10. A server, comprising:
memory for storing logs collected in real time for a user who accesses a shopping site; and
a processor for generating a Uniform Resource Identifier (URI) sequence corresponding to online behavior of the user by arranging the logs in temporal sequence, and for calculating a product purchase probability of the user by comparing the URI sequence with a purchase probability model corresponding to the shopping site.
